(19) United States
(12) Patent Application Publication
(10) Pub. No.: US 2013/0166955 A1
(43) Pub. Date: Jun. 27, 2013

(54) KEYBOARD AUTOMATIC TEST METHOD AND SYSTEM USING THE SAME

(71) Applicants: Wen-Chun Tsao, New Taipei City (TW); Yu-Wei Tsao, New Taipei City (TW)

(72) Inventors: Wen-Chun Tsao, New Taipei City (TW); Yu-Wei Tsao, New Taipei City (TW)

(73) Assignee: Wistron Corporation, New Taipei City (TW)

(21) Appl. No.: 13/447,937

(22) Filed: Apr. 16, 2012

(30) Foreign Application Priority Data
Dec. 22, 2011 (TW) 100148000

(51) Int. Cl. G06F 11/28

(52) U.S. Cl. 714/32; 714/E11.178

(57) ABSTRACT

A keyboard automatic test method is provided. A keyboard test unit first outputs a key test command to a keyboard controller. The key test command represents a trigger element of a keyboard is triggered. The keyboard controller generates a corresponding code corresponding to the trigger element. The keyboard test unit then determines whether a relationship between the corresponding code and the trigger element is correct.

This application claims the benefit of Taiwan application Serial No. 100148000, filed Dec. 22, 2011, the subject matter of which is incorporated herein by reference.

### BACKGROUND OF THE INVENTION

1. Field of the Invention

The invention relates to a keyboard automatic test method and a system using the same.

2. Description of the Related Art

All keyboard devices need to undergo tests during a manufacturing process to ensure normal functions of the keyboard devices. Tests for a keyboard device include tests on a circuit board of the keyboard device and all-round tests on the completed keyboard device. A main purpose of the tests is naturally to check whether keys of a keyboard are capable of outputting correct scan codes after being presses.

However, conventional keyboard tests are faced with issues of increased time and human costs as the keyboards are tested by manually pressing keys of the keyboards.

### SUMMARY OF THE INVENTION

The invention is directed to a keyboard automatic test method and a keyboard automatic test system using the keyboard automatic test method, which is capable of automatically testing keyboard functions to save testing time and human costs.

According to an embodiment of the present invention, a keyboard automatic test method is provided. In the method, a keyboard test unit first outputs a key test command to a keyboard controller. The key test command represents that a trigger element of a keyboard is triggered. The keyboard controller generates a corresponding code corresponding to the trigger element. The keyboard test unit then determines whether a relationship between the corresponding code and the trigger element is correct.

According to another embodiment, a keyboard automatic test system is provided. The keyboard automatic test system includes a keyboard controller and a keyboard test unit. The keyboard test unit outputs a key test command to the keyboard controller. The key test command represents that a trigger element of a keyboard is triggered. The keyboard controller generates a corresponding code corresponding to the trigger element. The keyboard test unit then determines whether a relationship between the corresponding code and the trigger element is correct.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a keyboard automatic test system according to one embodiment of the present invention.

FIG. 2 is a flowchart of a keyboard automatic test method according to one embodiment of the present invention.

FIG. 3 is a block diagram of a keyboard automatic test system according to another embodiment of the present invention.

FIG. 4 is a block diagram of a keyboard automatic test system according to yet another embodiment of the present invention.

### DETAILED DESCRIPTION OF THE INVENTION

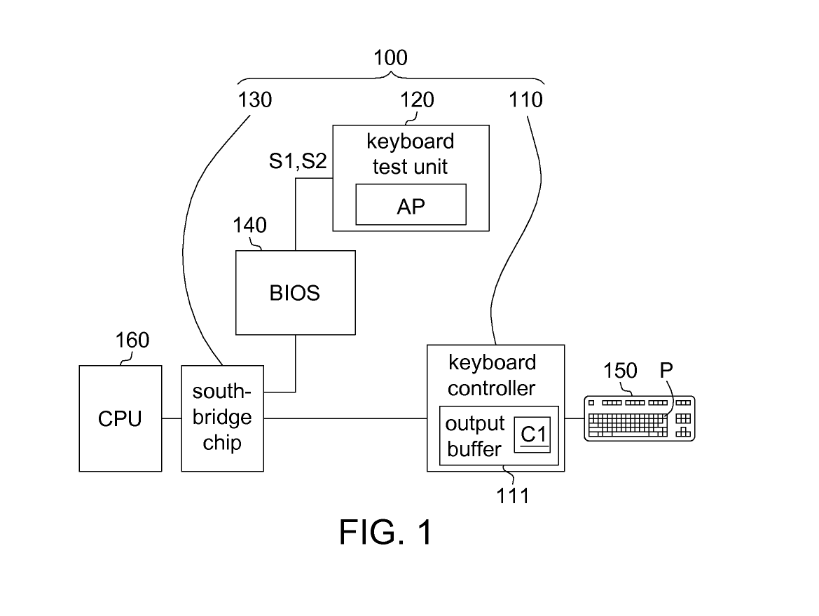

FIG. 1 shows a block diagram of a keyboard automatic test system according to one embodiment of the present invention. A keyboard automatic test system 100 includes a keyboard controller 110, a keyboard test unit 120, a south-bridge chip 130, a basic input/output system (BIOS) 140 and a central processing unit (CPU) 160.

Through the south-bridge chip 130, the CPU 160 communicates with the BIOS 140, the keyboard controller 110 and other peripheral elements.

A code of the BIOS 140 may be preloaded in the south-bridge chip 130 to allow the keyboard controller 110 and the keyboard test unit 120 to communication with the BIOS 140.

For example, the keyboard test unit 120 is an integrated circuit for executing an application program. Alternatively, the keyboard test unit 120 is firmware. In an embodiment, the keyboard test unit 120 is disposed independently from the CPU 160 (and may be electrically connected). Alternatively, the keyboard test unit 120 is integrated in the CPU 160.

The keyboard test unit 120 outputs a key test command S1 to the keyboard controller 110. The key test command S1 represents that a trigger element of the keyboard 150 is triggered. For example, the trigger element is a key (a single key or a hotkey combination) of the keyboard 150, a switch or a trigger element in another form. By triggering the trigger element, functions such as document processing, wireless network module enable/disable, speaker volume control and peripheral element control may be performed.

The keyboard controller 110 generates a corresponding code C1 corresponding to the trigger element. The key test unit 120 determines whether a relationship between the corresponding code C1 and the trigger element is correct. Thus, a test on the trigger element of the keyboard may be automatically completed via the keyboard automatic test system 100 according to the embodiment.

The keyboard controller 110, electrically connected to the keyboard 150, includes an output buffer 111, in which data (e.g., the corresponding code C1) generated by the keyboard controller 110 is temporarily stored.

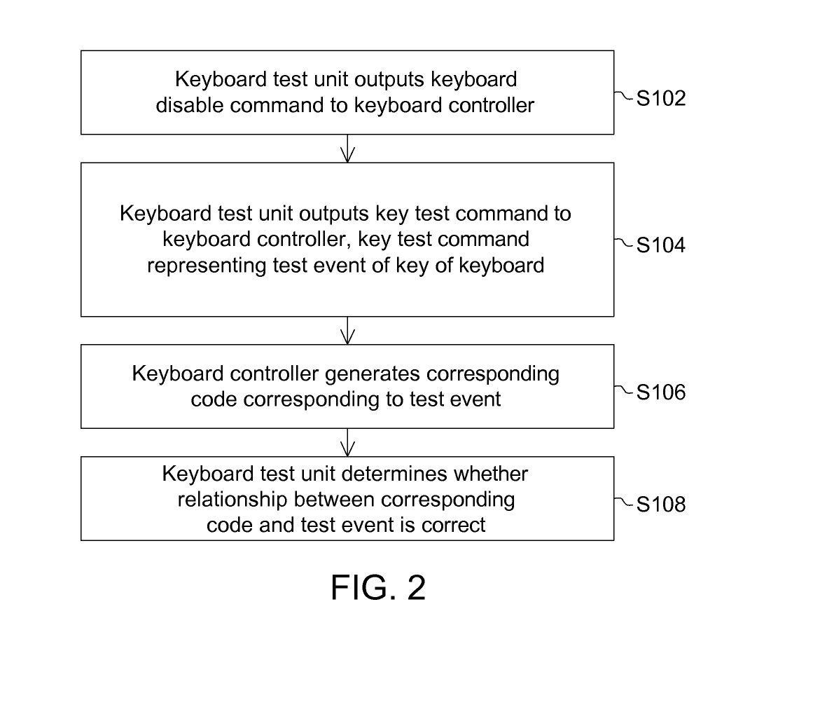

FIG. 2 shows a flowchart of the keyboard automatic test method according to one embodiment of the present invention.

Referring to FIGS. 1 and 2, in Step S102, the keyboard test unit 120 outputs a keyboard disable command S2 to the keyboard controller 110 to disable the communication between the keyboard 150 and the keyboard controller 110, thereby preventing unintentional triggering of the key or switch of the keyboard under test. For example, the keyboard controller 110 performs the disable step through firmware or by executing another unit.

In present embodiment, data 0x80 is written to an address 0x08 in the keyboard controller 110 and data 0xCF is written to an address 0x00 in the keyboard controller 110 to disconnect the communication between the keyboard 150 and the keyboard controller 110.

In Step S104, the keyboard test unit 120 outputs the key test command S1 to the keyboard controller 110. The key test command S1 represents that the trigger element of the keyboard 150 is triggered. In present embodiment, “single key is pressed” as the key test command S1 is taken as an example for explaining the embodiment.

Taking a single key of the letter “P” as the trigger element for example, a column and a row of a coordinate of the single key P on the keyboard are value 4 and 3 respectively.

Step S104 includes sub-steps below. The keyboard test unit 120 first writes the value 4 (representing the column of coordinate) to an address 0x07 in the keyboard controller 110, the value 3 (representing the row of coordinate) to an address 0x06 in the keyboard controller 110, and an event 0x10 to an address 0x08 in the keyboard controller 110. The event 0x10 represents “being pressed”. In short, the sub-steps above mean that “single key P is pressed”.

In Step S106, the keyboard controller 110 generates the corresponding code C1 corresponding to the single key P. For example, for an instance of a single key P, the corresponding code C1 is a scan code.

Step S106 includes sub-steps below. The keyboard test unit 120 first writes data 0xCF to an address 0x00 in the keyboard controller 110, reads the data in the addresses 0x06, 0x07 and 0x08 (i.e., reads the row number, the column number and the event), generates the corresponding code C1 (e.g., a scan code 0x1E) corresponding to the single key P and stores the corresponding code C1 in the output buffer 111 of the keyboard controller 110. The keyboard controller 110 then sends an interrupt request IRQ1 via the south-bridge chip 130 to the CPU 160 (rather, to an operating system), which then reads the corresponding code C1 in the output buffer 111 according to the interrupt request IRQ1.

In Step S108, the keyboard test unit 120 determines whether the relationship between the corresponding code C1 and the single key P is correct. A correct relationship indicates a successful test; that is, wiring and control designs between the keyboard 150 and the keyboard controller 110 are correct.

In present embodiment, the keyboard test unit 120 executes a predetermined subroutine GetAsynKeyState(Virtual_Key_Codes). When a replied value is 1, it means the single key P is pressed, and the keyboard test unit 120 accordingly determines the relationship between the corresponding code and the single key P is correct. Conversely, when the replied value is 0, it means the single key P is not pressed, and the keyboard test unit 120 accordingly determines the relationship between the corresponding code C1 and the single key P is incorrect.

Steps S104 to S108 may be repeated to test other single keys. The communication between the keyboard 150 and the keyboard controller 110 is restored after the test is fully completed. In present embodiment, data 0x81 is written to the address 0x08 in the keyboard controller 110 and the data 0xCF is written to the address 0x00 in the keyboard controller 110 to restore the communication between the keyboard 150 and the keyboard controller 110.

In the description below, the trigger element is a specific function key, and a wireless network hotkey W1 is taken as an example for explaining the keyboard automatic test method according to one embodiment.

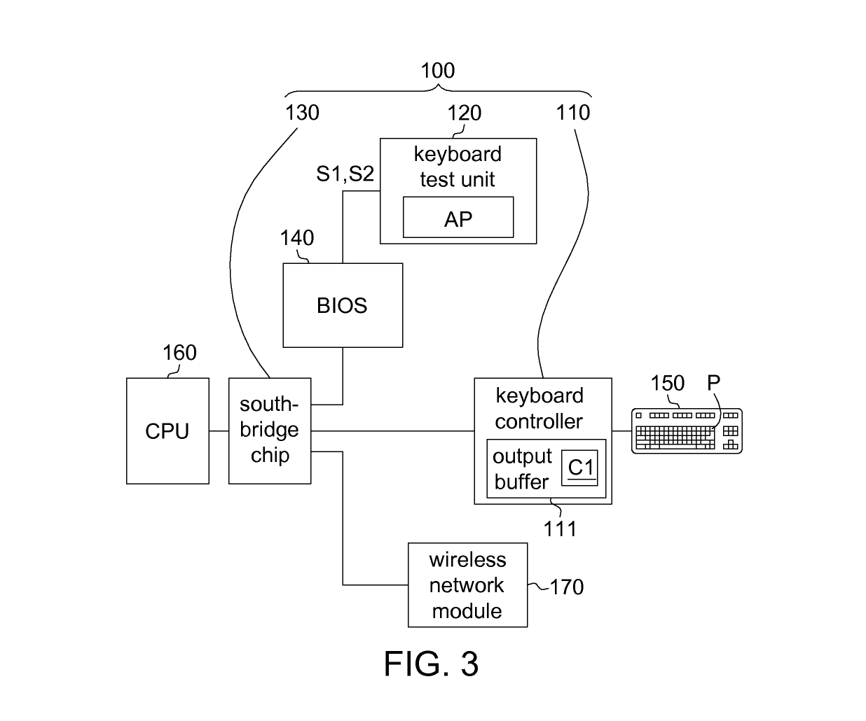

FIG. 3 shows a block diagram of a keyboard automatic test method according to another embodiment of the present invention.

Referring to FIGS. 2 and 3, in Step S102, the keyboard test unit 120 outputs the keyboard disable command S2 to the keyboard controller 110 to disable the communication between the keyboard 150 and the keyboard controller 110.

In Step S104, the keyboard test unit 120 outputs the key test command S1 to the keyboard controller 110. The key test command S1 represents the wireless network hotkey W1 of the keyboard 150 is triggered. In present embodiment, the key test command S1 is “enabling wireless network module 170”, for example. Further, the wireless network hotkey W1 may also be a key or a switch, e.g., a finger-flip switch.

Step S104 includes sub-steps below. The keyboard test unit 120 first writes an identification code 0x02 of the wireless network hotkey W1 to the address 0x07 in the keyboard controller 110 and an event 0x20 to the address 0x08 in the keyboard controller 110. The event 0x20 means “enable”. In short, the sub-steps above mean “enable wireless network hotkey W1”.

In Step S106, the keyboard controller 110 generates the corresponding code C1 corresponding to the wireless network hotkey W1. For example, for an instance of a specific function key, the corresponding code C1 is a scan code or an SCI code.

Step S106 includes sub-steps below. The keyboard test unit 120 first writes data 0xCF to the address 0x00 in the keyboard controller 110, reads the data in the addresses 0x07 and 0x08, generates the corresponding code C1 (e.g., a scan code 0x1E) corresponding to the test event and stores the corresponding code C1 in the output buffer 111 of the keyboard controller 110. The keyboard controller 110 then sends the interrupt request IRQ1 via the south-bridge chip 130 to the CPU 160 (rather, to the operating system), which then reads the corresponding code C1 in the output buffer 111 according to the interrupt request IRQ1. According to the corresponding code C1, the CPU 160 controls the wireless network module 170 to performs a function corresponding to the corresponding code C1, i.e., enabling the function of the wireless network module 170, given that the corresponding code C1 is correct.

In Step S108, the keyboard test unit 120 determines whether the relationship between the corresponding code C1 and the wireless network hotkey W1 is correct.

Step S108 includes sub-steps below. The keyboard test unit 120 first determines whether the function performed by the wireless network module 170 corresponds to the function represented by the wireless network hotkey W1. When the function performed by the wireless network module 170 corresponds to the function represented by the wireless network hotkey W1, the keyboard test unit 120 determines that the relationship between the corresponding code C1 and the wireless network hotkey W1 is correct.

In present embodiment, for example, the keyboard test unit 120 outputs an echo request packet, and determines whether the wireless network module 170 is connected to an external network according to a corresponding echo reply packet. When the wireless network module 170 is connected to an external network, it is determined that the relationship between the corresponding code C1 and the wireless network hotkey W1 is correct. In another embodiment, for example, the keyboard test unit 120 executes a predetermined subroutine, and determines whether the relationship between the corresponding code C1 and the wireless network hotkey W1 is correct according to a replied value.

The steps above may be repeated to test other specific function keys. The communication between the keyboard a150 and the keyboard controller 110 is restored after the test is fully completed.

In the description below, the trigger element is a hotkey combination, and a hotkey combination of a first key Fn and a second key F11 is taken as an example for explaining the keyboard automatic test method according to one embodiment.

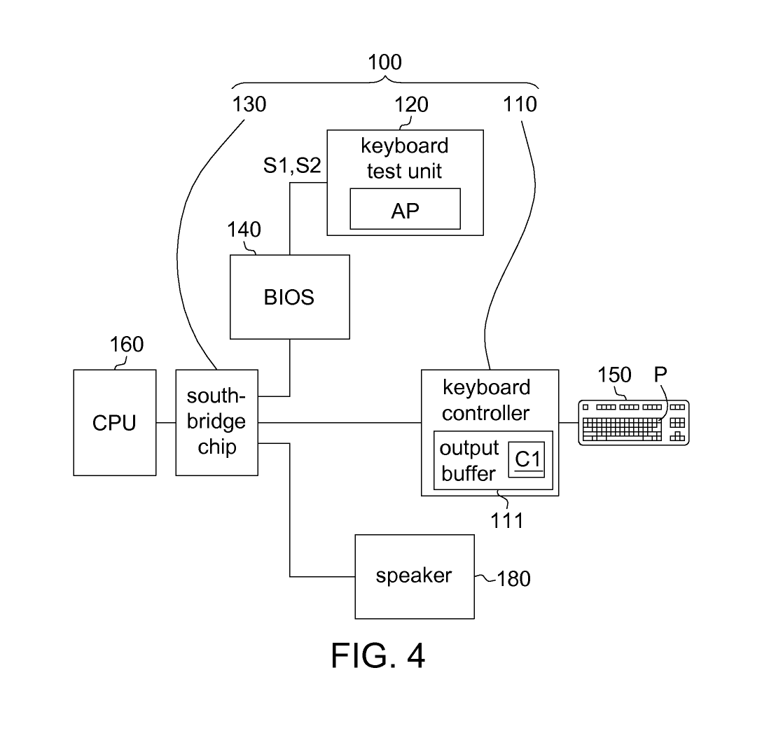

FIG. 4 shows a block diagram of a keyboard automatic test method according to another embodiment of the present invention.

Referring to FIGS. 2 and 4, in Step S102, the keyboard test unit 120 outputs the keyboard disable command S2 to the keyboard controller 110 to disable the communication between the keyboard 150 and the keyboard controller 110.

In Step S104, the keyboard test unit 120 outputs the key test command S1 to the keyboard controller 110. The key test command S1 represents a hotkey combination H of the keyboard 150 is triggered. In present embodiment, the hotkey combination H includes the first key Fn and the second key F11, and represents “turn up speaker volume”.

Step S104 includes sub-steps below. The keyboard test unit 120 first outputs a first key test command S11 to the keyboard controller 110. The first key test command S11 represents that the first key Fn of the hotkey combination H is triggered. The keyboard controller 110 generates the corresponding code corresponding to the first key Fn, and then generates a second key test command S12 to the keyboard controller 110. The second key test command S12 represents that the second key F11 of the hotkey combination H is triggered.

In Step S106, the keyboard controller 110 generates the corresponding code C1 corresponding to the hotkey combination H. For example, for an instance of a specific function key, the corresponding code C1 is a scan code.

In present embodiment, the keyboard controller 110 determines that the first key Fn and the second key F11 are the hotkey combination H according to the first key Fn, accordingly generates the corresponding code C1 (e.g., scan codes 0x0E and 0x30) corresponding to the hotkey combination H, stores the corresponding code C1 in the output buffer 111 of the keyboard controller 10 and outputs the interrupt request IRQ1 via the south-bridge chip 130 to the CPU 160 (rather, the operating system). According to the corresponding code C1, the CPU 160 reads the corresponding code according to the interrupt request IRQ1, and performs a function corresponding to the corresponding code C1, i.e., turning up the speaker volume, given that the corresponding code C1 is correct.

In Step S108, the keyboard test unit 120 determines whether the relationship between the corresponding code C1 and the hotkey combination H is correct.

Step S108 includes sub-steps below. The keyboard test unit 120 first determines whether the function performed by a speaker 180 corresponds to the function represented by hotkey combination H. When the function performed by the speaker 180 corresponds to the function represented by the hotkey combination H, the keyboard test unit 120 determines that the relationship between the corresponding code C1 and the hotkey combination H is correct.

In present embodiment, for example, the keyboard test unit 120 performs a predefined subroutine GetMasterVolumeLevelScalar(&CurrentVolume), and determines whether the relationship between the corresponding code C1 and the hotkey combination H is correct according to a replied value.

The steps above may be repeated to test other hotkey combinations. The communication between the keyboard 150 and the keyboard controller 110 is restored after the test is fully completed.

Therefore, with the keyboard automatic test system implementing the keyboard automatic test method according to the embodiments of the present invention, keyboard functions are automatically tested to save testing time and human costs.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A keyboard automatic test method, comprising:
a keyboard test unit outputting a key test command to a keyboard controller, wherein the key test command represents a trigger element of a keyboard which is triggered;
the keyboard controller generating a corresponding code corresponding to the trigger element; and
the keyboard test unit determining whether a relationship between the corresponding code and the trigger element is correct.

2. The method according to claim 1, further comprising:
the keyboard test unit outputting a keyboard disable command to the keyboard controller to disable a communication between the keyboard and the keyboard controller.

3. The method according to claim 1, wherein the trigger element is a predetermined function key, the method further comprising:
a central processor (CPU) controlling a hardware element to perform a corresponding function according to the corresponding code;
wherein, the step of the keyboard test unit determining whether the relationship between the corresponding code and the trigger element is correct comprises:
the keyboard test unit determining whether the function performed by the hardware element corresponds to a function represented by the trigger element; and
if the function performed by the hardware element corresponds to a function represented by the trigger element, the keyboard test unit determining the relationship between the corresponding code and the trigger element is correct.

4. The method according to claim 1, wherein the trigger element is a hotkey combination, and the step of the keyboard test unit outputting the key test command to the keyboard controller comprises:
the keyboard test unit outputting a first key test command to the keyboard controller, wherein the first key test command representing a first key of the hotkey combination is triggered; and
the keyboard test unit outputting a second key test command to the keyboard controller, wherein the second key test command represents a second key of the hotkey combination is triggered.

5. The method according to claim 4, further comprising:
a CPU controlling a hardware element to perform a corresponding function according to the corresponding code;
wherein, the step of the keyboard test unit determining whether the relationship between the corresponding code and the trigger element is correct comprises:
the keyboard test unit determining whether the function performed by the hardware element corresponds to a function represented by the trigger element; and
if the function performed by the hardware element corresponds to a function represented by the trigger element, determining the relationship between the corresponding code and the trigger element is correct by the keyboard test unit.

6. A keyboard automatic test system, comprising:
a keyboard controller; and
a keyboard test unit, for outputting a key test command to the keyboard controller, the key test command representing a trigger element of a keyboard which is triggered;
wherein, the keyboard controller generates a corresponding code corresponding to the trigger element, and the keyboard test unit determines whether a relationship between the corresponding code and the trigger element is correct.

7. The system according to claim 6, wherein the keyboard test unit outputs a keyboard disable command to the keyboard controller to disable a communication between the keyboard and the keyboard controller.

8. The system according to claim 6, wherein the trigger element is a predetermined function key, the system further comprising:
a CPU, for controlling a hardware element to perform a corresponding function according to the corresponding code;
wherein, the keyboard test unit determines whether the function performed by the hardware corresponds to a function represented by the trigger element; and if the function performed by the hardware corresponds to the function represented by the trigger element, the keyboard test unit determines the relationship between the corresponding code and the trigger element is correct.

9. The system according to claim 6, wherein the trigger element is a hotkey combination; the keyboard test unit outputs a first key test command to the keyboard controller, the first key test command representing a first key of the hotkey combination is triggered; and the keyboard test unit outputs a second key test command to the keyboard controller, the second key test command representing a second key of the hotkey combination is triggered.

10. The system according to claim 9, further comprising:
a CPU, for controlling a hardware element to perform a corresponding function according to the corresponding code;
wherein, the keyboard test unit determines whether the function performed by the hardware corresponds to a function represented by the trigger element; and if the function performed by the hardware corresponds to the function represented by the trigger element, the keyboard test unit determines the relationship between the corresponding code and the trigger element is correct.
